(19) United States
(12) Patent Application Publication
(10) Pub. No.: US 2024/0427540 A1
(43) Pub. Date: Dec. 26, 2024

(54) INFORMATION PROCESSING SYSTEM, METHOD, AND NON-TRANSITORY COMPUTER READABLE MEDIUM

(71) Applicant: FUJIFILM Business Innovation Corp., Tokyo (JP)

(72) Inventors: Takayuki SAITO, Kanagawa (JP); Hiroyuki TOJO, Kanagawa (JP)

(73) Assignee: FUJIFILM Business Innovation Corp., Tokyo (JP)

(21) Appl. No.: 18/501,151

(22) Filed: Nov. 3, 2023

(30) Foreign Application Priority Data
Jun. 20, 2023 (JP) 2023-101234

(51) Int. Cl. G06F 3/12; G06K 15/00

(52) U.S. Cl. CPC G06F 3/1257; G06F 3/1204; G06K 15/4065

(57) ABSTRACT

An information processing system includes a processor configured to: register plural pieces of correlation information indicating correlation between a tray and paper information about paper and registration information in which at least one of the plural pieces of correlation information and identification information are correlated with each other; and execute a print process when identification information included in received print data matches identification information in the registration information, the print process being executed using the paper information based on the registration information with the matching identification information.

### CROSS-REFERENCE TO RELATED APPLICATIONS

This application is based on and claims priority under 35 USC 119 from Japanese Patent Application No. 2023-101234 filed Jun. 20, 2023.

### BACKGROUND

### (i) Technical Field

The present disclosure relates to an information processing system, a method, and a non-transitory computer readable medium.

### (ii) Related Art

Japanese Unexamined Patent Application Publication No. 2011-062929 discloses an information processing apparatus including: a storage unit that stores first paper attribute information defining the attribute of paper for a tray that stores the paper and second paper attribute information defining the attribute of paper for a tray that stores the paper and being effective only for a predetermined period; a selection unit that selects paper attribute information specified by a user from among the first and second paper attribute information stored in the storage unit; an image formation control unit that performs control so as to form an image in accordance with the paper attribute information selected by the selection unit; and a storage control unit that performs control so as to store the second paper attribute information in the storage unit as the first paper attribute information and delete the second paper attribute information from the storage unit when the number of times of use of the second paper attribute information by the image formation control unit reaches a predetermined number.

Japanese Unexamined Patent Application Publication No. 2022-021843 discloses an image forming apparatus including: a reception unit that receives a print job; a setting unit that makes paper setting at a paper supply section on the basis of instruction information for instructing the paper supply section to make the paper setting when such instruction information is included in the print job; and an execution unit that executes printing on the basis of the print job.

Japanese Unexamined Patent Application Publication No. 2011-113146 discloses an information processing apparatus including: an attribute combination storage unit that stores a combination of a plurality of attribute values about recording paper; a group storage unit that stores a plurality of combinations of the plurality of attribute values as a group; and an allocation unit that allocates a combination of the plurality of attribute values matching the specifications of a recording paper storage unit for each recording paper storage unit in the group, the recording paper storage unit being provided in an image forming apparatus to store recording paper.

### SUMMARY

There is provided an image forming apparatus that executes a print process for one piece of print data to be printed using one or more types of paper. A user correlates a tray to be used in the print process and paper information about the type etc. of paper stored in the tray, and outputs the print data to the image forming apparatus. The correlation work may be complicated when there are a large number of trays to be used in the print process and a large number of types of paper to be used in the print process.

Aspects of non-limiting embodiments of the present disclosure relate to providing an information processing system capable of executing a print process using paper information about a tray specified in print data without a user using a screen of an image forming apparatus when outputting the print data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: register a plurality of pieces of correlation information indicating correlation between a tray and paper information about paper and registration information in which at least one of the plurality of pieces of correlation information and identification information are correlated with each other; and execute a print process when identification information included in received print data matches identification information in the registration information, the print process being executed using the paper information based on the registration information with the matching identification information.

### BRIEF DESCRIPTION OF THE DRAWINGS

An exemplary embodiment of the present disclosure will be described in detail based on the following figures, wherein:

FIG. 1 schematically illustrates an information processing system according to the present exemplary embodiment;

FIG. 2 is a block diagram illustrating the configuration of an image forming apparatus according to the present exemplary embodiment;

FIG. 3 illustrates the details of correlation information registered in a storage section of the image forming apparatus;

FIG. 4 illustrates an example of a principal screen to be displayed on a user interface;

FIG. 5 illustrates a setting screen to be displayed on the user interface when an icon is selected;

FIG. 6 illustrates an example of a screen to be displayed on the user interface when “library” is selected;

FIG. 7 illustrates an example of a screen to be displayed on the user interface when “recommended paper information list” is selected;

FIG. 8 illustrates an example of a screen to be displayed on the user interface when “create new” is selected;

FIG. 9 illustrates an example of updated correlation information;

FIG. 10 is an example of a block diagram illustrating the configuration of a personal computer (PC) and a server;

FIG. 11 is a flowchart illustrating operation of the server to output print data to the image forming apparatus;

FIG. 12 illustrates an example of a print information setting screen to be displayed on a display section of the PC;

FIG. 13 illustrates an example of a management table stored in the storage section of the image forming apparatus;

FIG. 14 is a flowchart illustrating operation of the image forming apparatus;

FIG. 15 is a flowchart illustrating another example of operation of the image forming apparatus; and

FIG. 16 illustrates an example of an updated management table.

### DETAILED DESCRIPTION

An exemplary embodiment of the present disclosure will be described below with reference to the drawings.

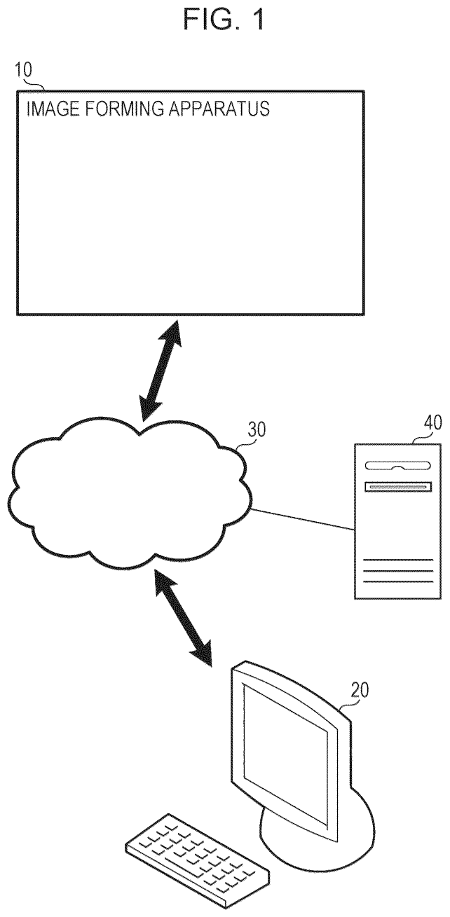

First, the present exemplary embodiment will be schematically described below with reference to FIG. 1.

The present exemplary embodiment is configured to include an image forming apparatus 10, a personal computer (PC) 20, and a network 30. A print setting system is provided on the network 30 by a server 40. The image forming apparatus 10, the PC 20, and the server 40 are connected to each other via various communication lines.

The configuration illustrated in FIG. 1 is exemplary. The present exemplary embodiment may be configured to include only the image forming apparatus 10 and the PC 20, for example. In this case, the print setting system provided by the server 40 may be provided in advance in the PC 20.

The image forming apparatus 10 is an example of an “information processing system”. The information processing system may be a single device, or may be constituted using a plurality of devices. The image forming apparatus 10 includes an in-house image forming apparatus that executes a document printing process caused through an in-house material copying process, paperwork, etc., and a production image forming apparatus (production printer) that executes a print process on various types of paper.

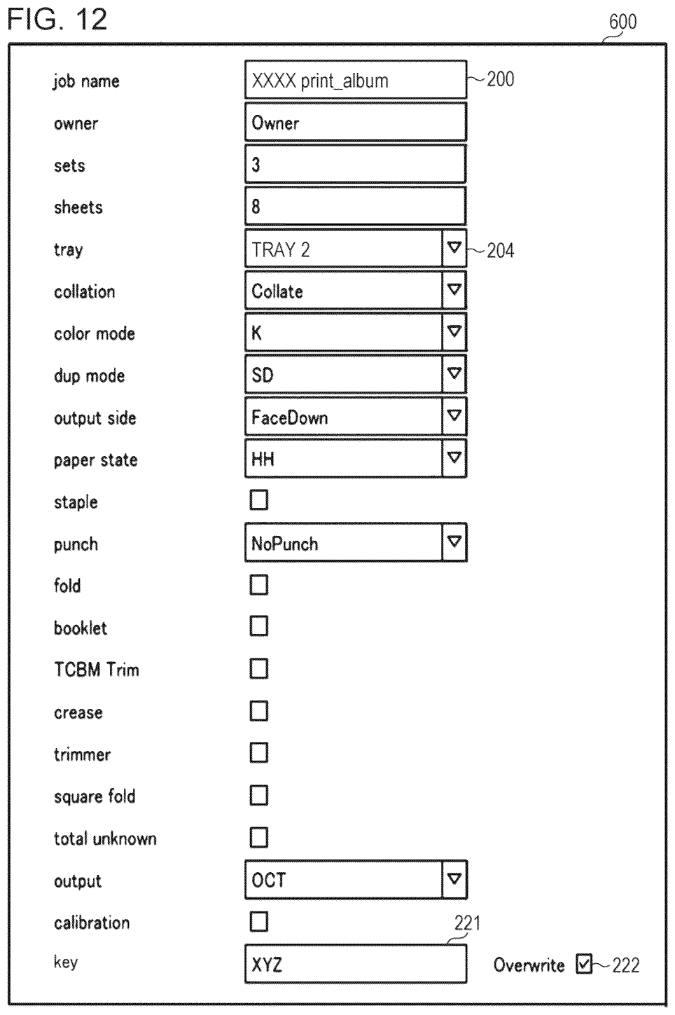

In the present exemplary embodiment, a user is able to set print information for data to be printed in the print setting system. Print data including the set print information and data are output to the image forming apparatus 10 by the server 40, for example. The setting of the print information will be discussed in detail later (see FIG. 12).

Next, the configuration of the image forming apparatus 10 will be described.

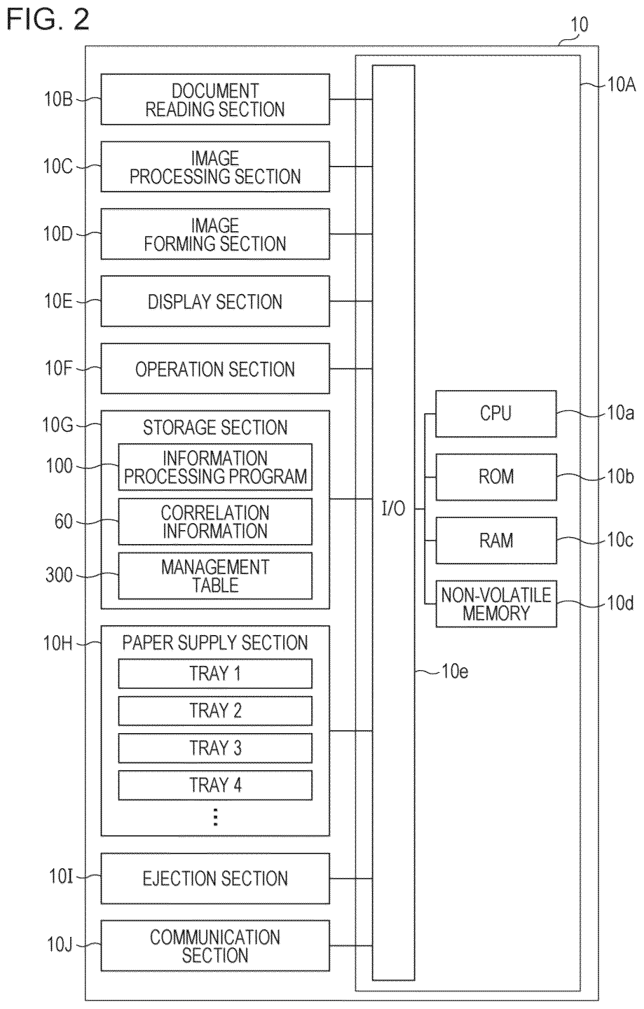

FIG. 2 is a block diagram illustrating the configuration of the image forming apparatus 10 according to the present exemplary embodiment.

The image forming apparatus 10 according to the present exemplary embodiment illustrated in FIG. 2 includes a processor 10A, a document reading section 10B, an image processing section 10C, an image forming section 10D, a display section 10E, an operation section 10F, a storage section 10G, a paper supply section 10H, an ejection section 10I, and a communication section 10J. The processor 10A includes a central processing unit (CPU) 10a, a read only memory (ROM) 10b, a random access memory (RAM) 10c, a non-volatile memory 10d, and an input/output interface (I/O) 10c.

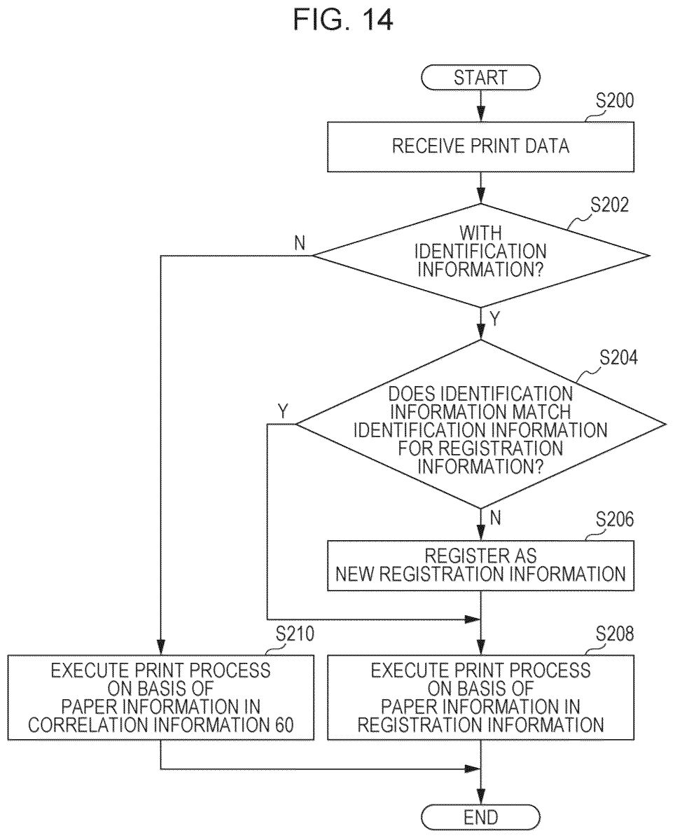

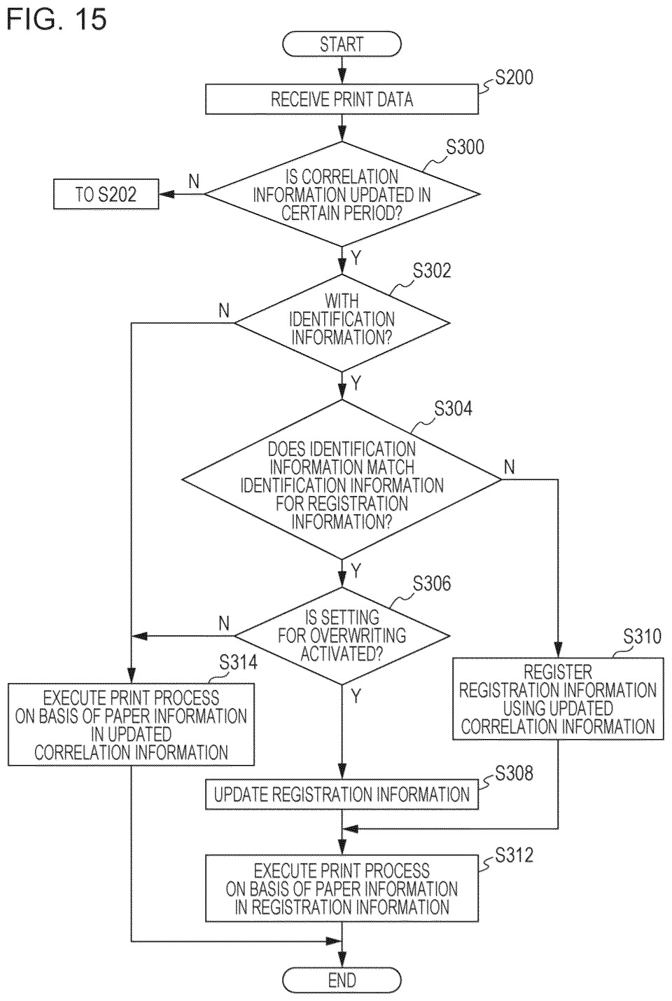

The processor 10A is a central processing unit, and reads an information processing program 100 and other various programs from at least one of the ROM 10b, the non-volatile memory 10d, and the storage section 10G, for example. The information processing program 100 will be discussed in detail later (see FIGS. 14 and 15). The processor 10A controls the image forming apparatus 10 by executing the read programs using the RAM 10c as a work area.

The CPU 10a, the ROM 10b, the RAM 10c, and the non-volatile memory 10d are communicably connected to the input/output interface 10e via a bus.

The document reading section 10B includes a charge-coupled device (CCD) image sensor etc. that executes a document reading process, for example. The document reading section 10B is implemented by an image scanner, for example.

The image processing section 10C executes image processing to generate a document image from a document read by the document reading section 10B.

The image forming section 10D executes an image forming process including a print process of printing a document image generated by the image forming section 10D, or an image based on received print data, on paper using electrophotography, an inkjet recording system, etc., for example.

The display section 10E is constituted by a liquid crystal display, an organic electro-luminescence (EL) display, etc., for example. The display section 10E displays information etc. that matches a user operation, processing by the image forming apparatus 10, etc.

The operation section 10F includes an operation key, an operation button, a power source button, etc. of the image forming apparatus 10. The operation section 10F and the display section 10E may be constituted integrally as a touch screen etc., for example. Hereinafter, the display section 10E and the operation section 10F will be collectively referred to as a “user interface 10K”.

The storage section 10G is constituted by a solid state drive (SSD) or a hard disk drive (HDD), for example. The storage section 10G stores the information processing program 100, correlation information 60, a management table 30, and various programs, for example. The information processing program 100, the correlation information 60, and the management table 30 will be discussed in detail later.

The paper supply section 10H includes a plurality of trays that store a plurality of types of paper, with each tray storing each type of paper. While a tray 1, a tray 2, a tray 3, and a tray 4 are illustrated as representatives in FIG. 2, the number of trays is not limited to this example.

The ejection section 10I stores printed matter generated through the print process, for example.

The communication section 10J is an interface communicably connected to the server 40, the PC 20, etc. The communication section 10J uses a communication standard such as Wi-Fi (registered trademark), Bluetooth (registered trademark), and a local area network (LAN), for example.

The processor 10A, the document reading section 10B, the image processing section 10C, the image forming section 10D, the display section 10E, the operation section 10F, the storage section 10G, the paper supply section 10H, the ejection section 10I, and the communication section 10J are electrically connected through a system bus.

The image forming apparatus 10 may be provided with a component (not illustrated) that implements a function of binding printed matter through center bookbinding, for example, a function of sorting printed matter, etc.

The correlation information 60 stored in the storage section 10G will be described. A plurality of types of paper are stored in the plurality of trays of the paper supply section 10H according to the present exemplary embodiment, with each type of paper stored in each tray. The user correlates the trays and “paper information” that indicates the types etc. of paper stored in the trays, and registers such correlation in the storage section 10G in advance. The correlation between the trays and the paper information on the paper stored in the trays registered in advance by the user is referred to as “correlation information”. The correlation information is registered for each correlation between a tray and paper information. The correlation information 60 is a general term for a plurality of pieces of correlation information.

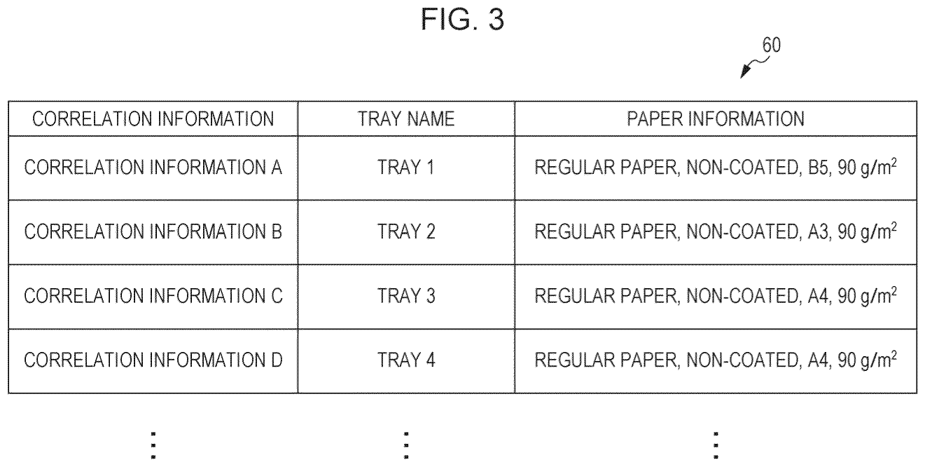

FIG. 3 illustrates the details of the correlation information 60 registered in the storage section 10G. When the user stores paper of “regular paper”, “non-coated”, “B5 size”, and “thickness: 90 g/square meter” in the tray 1, for example, the correlation between paper information on the paper and the tray 1 is registered in the storage section 10G as correlation information A. The paper information may include the name of the paper determined by the user, for example. When the name of the paper of “regular paper”, “non-coated”, “B5 size”, and “thickness: 90 g/square meter” stored in the tray 1 is set as “paper A”, for example, “paper A” is also included in the paper information. The correlation information is registered by operating the user interface 10K.

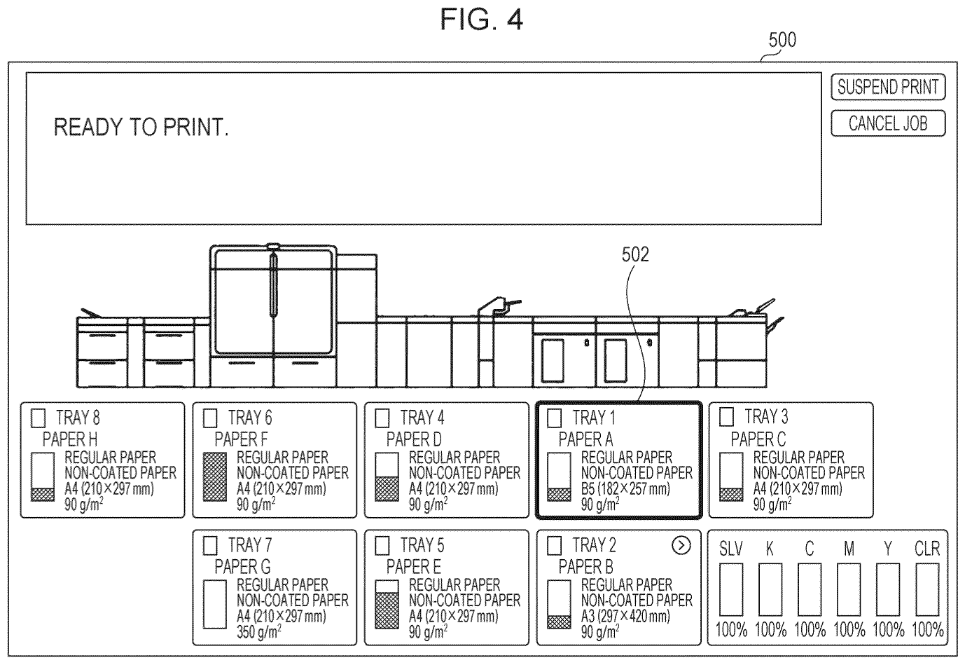

Registration of the correlation information 60 will be described in detail with reference to FIGS. 4 to 9.

FIG. 4 illustrates an example of a principal screen to be displayed on the user interface 10K. A principal screen 500 illustrated in FIG. 4 includes icons that indicate trays. Icons that indicate trays that store paper display paper information on the basis of the registered correlation information. For example, an icon 502 that indicates the tray 1 indicates paper information in the correlation information A in the correlation information 60 indicated in FIG. 3. The principal screen 500 allows the user to confirm what paper is stored in each tray.

When the user newly stores paper in a tray that does not store paper, or when the user changes paper stored in a tray, the user is able to correlate the target tray with new paper information. Specifically, setting about the correlation of paper information is made by selecting an icon for the target tray on the principal screen 500 illustrated in FIG. 4. This allows the target tray to be correlated with new paper information. New correlation information is registered in the storage section 10G when this setting is made. When the user changes the paper A stored in the tray 1 to different paper, the user selects the icon 502 on the principal screen 500. The processor 10A displays a screen for registering correlation information on the user interface 10K in accordance with the selected icon.

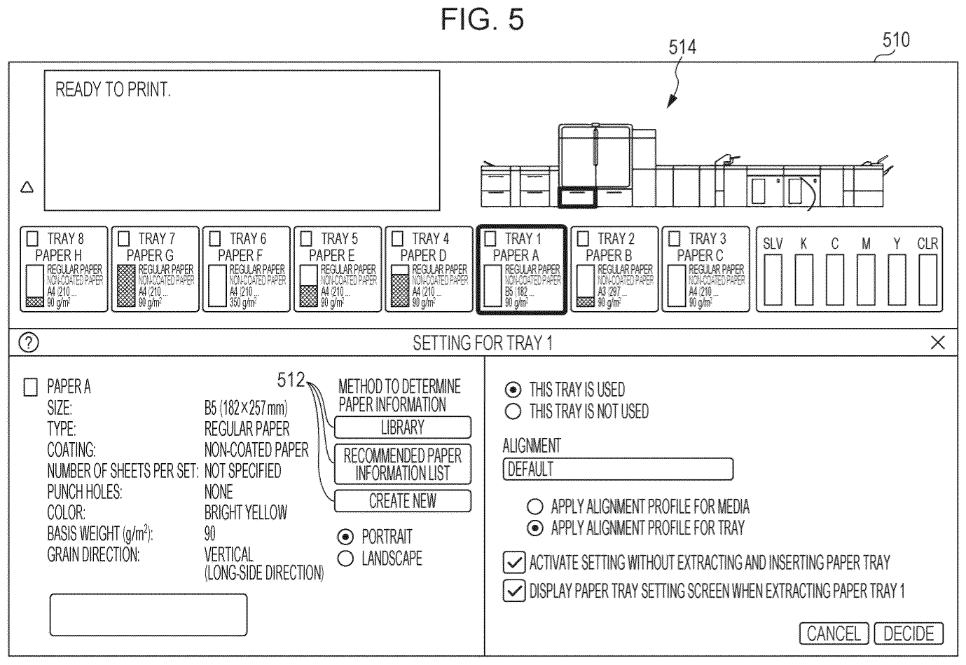

FIG. 5 illustrates a setting screen 510 to be displayed on the user interface 10K when the icon 502 illustrated in FIG. 4 is selected. On the setting screen 510, the user is able to select any of icons that indicate items 512 and set paper information for the tray 1, for example. Providing an object 514 etc. on the setting screen 510 allows the user to confirm which tray setting is presently made for etc.

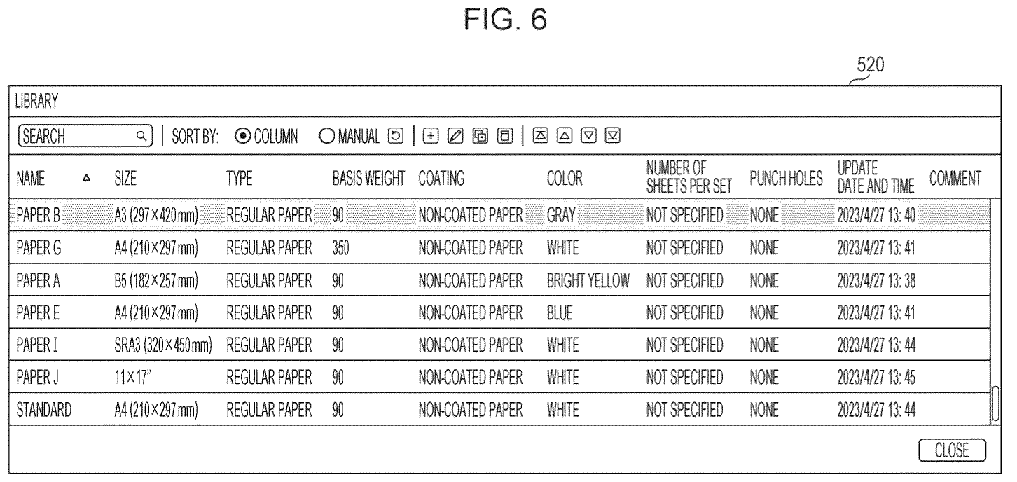

When “library” is selected from among the items 512 on the setting screen 510 illustrated in FIG. 5, the processor 10A displays a screen 520 illustrated in FIG. 6 on the user interface 10K. The screen 520 displays a list of paper information registered in advance in the image forming apparatus 10. When the user sets paper information for the tray 1 using the paper information registered in advance in the image forming apparatus 10, the user is able to select target paper information from the list of the paper information indicated on the screen 520 and set the selected paper information for the tray 1.

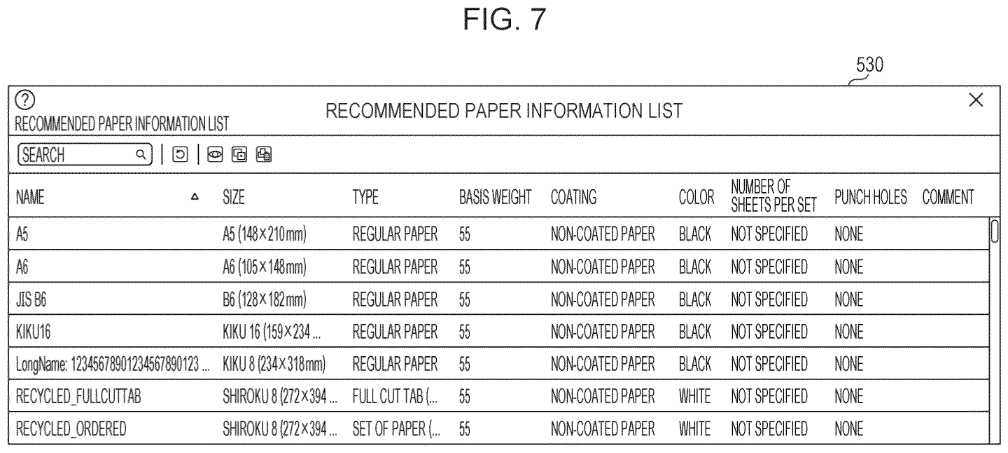

When “recommended paper information list” is selected from among the items 512 on the setting screen 510 illustrated in FIG. 5, the processor 10A displays a screen 530 illustrated in FIG. 7 on the user interface 10K. The screen 530 displays a list of paper information that is frequently used, for example. The user is able to select target paper information from the list of recommended paper information illustrated on the screen 530 and set the selected paper information for the tray 1, for example.

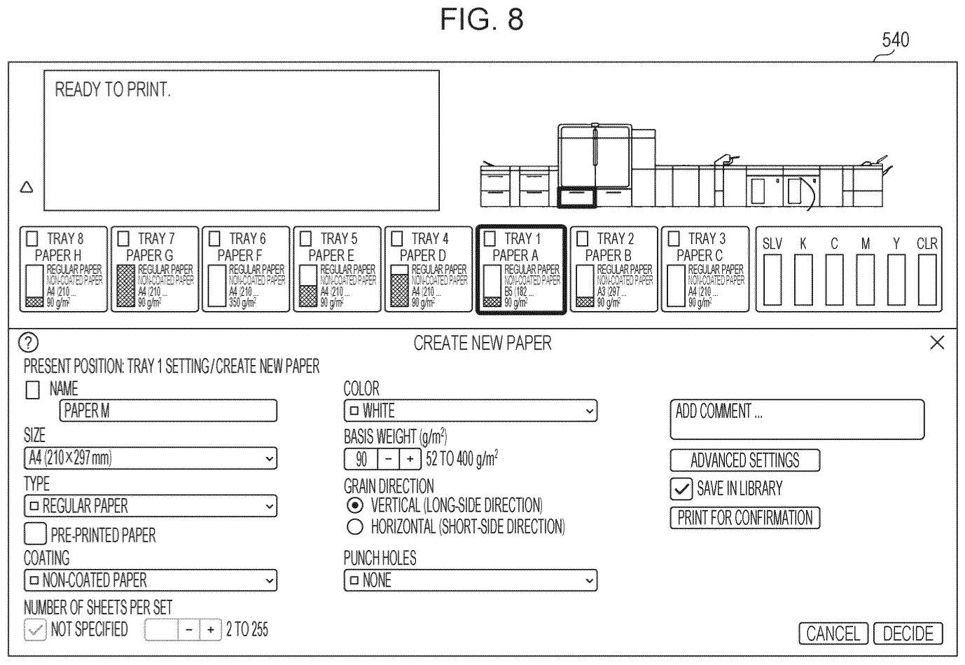

When “create new” is selected from among the items 512 on the setting screen 510 illustrated in FIG. 5, the processor 10A displays a screen 540 illustrated in FIG. 8 on the user interface 10K. Paper information for the tray 1 may be newly created on the screen 540. When paper with no paper information in “library” or “recommended paper information list” is to be stored in the tray 1, the user newly registers paper information on the screen 540, for example. The newly created paper information may be registered as paper information to be displayed in the list of “library”, for example.

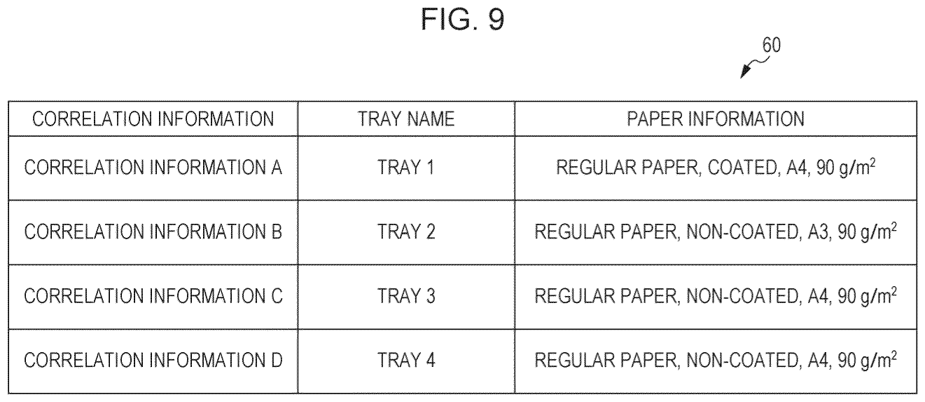

When paper information for a tray is newly set as paper stored in the tray is changed as described above, for example, the correlation information 60 is updated as indicated in FIG. 9. FIG. 9 illustrates an example of the correlation information 60 illustrated in FIG. 3 in which the correlation information A has been updated by registering correlation between the paper information newly created in FIG. 8 and the tray 1.

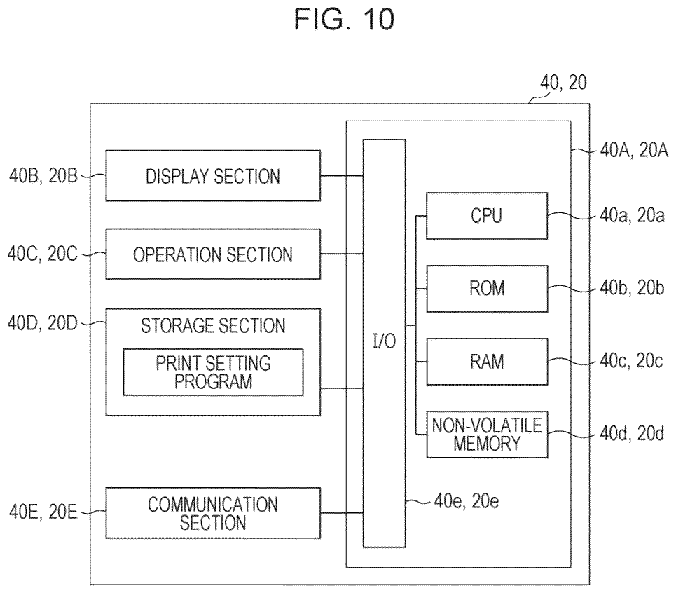

Next, the configuration of the PC 20 and the server 40 will be described. FIG. 10 is an example of a block diagram illustrating the configuration of the PC 20 and the server 40. Since the PC 20 and the server 40 are common computer components, the server 40 will be described below as a representative.

As illustrated in FIG. 10, the server 40 according to the present exemplary embodiment includes a processor 40A, a display section 40B, an operation section 40C, a storage section 40D, and a communication section 40E. The processor 40A includes a CPU 40b, a ROM 40b, a RAM 40c, a non-volatile memory 40d, and an input/output interface 40c, and governs operation of the entire server 40. For example, the ROM 40b stores various control programs, various parameters, etc. in advance. The RAM 40c is used as a work area etc. when the CPU 40a executes the various programs. The storage section 40D stores a print setting program (not illustrated), various data and application programs, etc. The operation section 40C is used to input various types of information. The display section 40B is used to display various types of information. The communication section 40E is an interface that transmits and receives various data to and from external devices such as the PC 20 and the image forming apparatus 10, for example. The communication section 40E may be configured to be able to communicate with various devices using near-field wireless communication such as Wi-Fi (registered trademark) and Bluetooth (registered trademark), for example. The various sections of the server 40 described above are electrically communicated to each other through a system bus.

While the storage section 40D stores the print setting program in the above description, the storage section 20D of the PC 20 may not store the print setting program. Meanwhile, the storage section 20D may store the print setting program in a configuration in which the PC 20 is not connected to the server 40, for example.

Next, operation of the server 40 to output print data to the image forming apparatus 10 will be described. While print data for executing a print process using a plurality of types of paper are output in the present exemplary embodiment, the print data may include a single page. Examples of the print data for executing a print process using a plurality of types of paper include print data for bookbinding. The print process for print data for bookbinding is executed with the type of paper changed in accordance with pages such as cover pages, inside cover pages, and body pages.

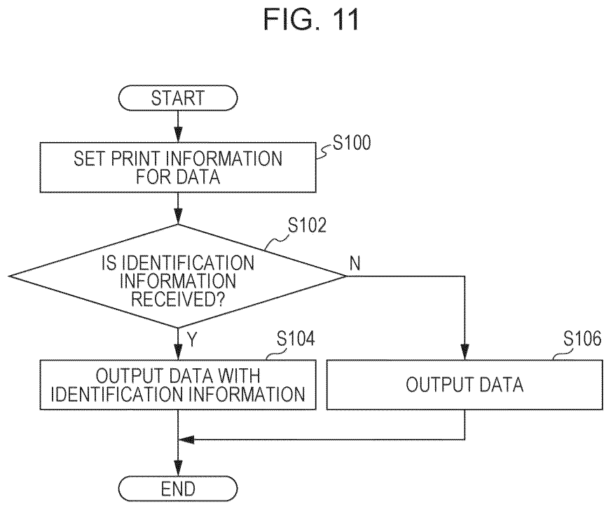

FIG. 11 is a flowchart illustrating operation of the server 40 to output print data to the image forming apparatus 10. The process illustrated in FIG. 11 is executed by the server 40 starting the print setting program upon receiving an instruction to start the print setting program from the PC 20.

In step S100, the processor 40A sets print information for data to be printed. The print information is information in which parameters necessary for a data print process are specified. The print information is set by the user on a print information setting screen 600 illustrated in FIG. 12 displayed on the display section 10E, for example.

The user is able to specify parameters for items indicated on the print information setting screen 600. For example, the user is able to specify a tray to be used in the print process in an item 204 on the print information setting screen 600. The image forming apparatus 10 acquires information on the tray specified in the print information, transports paper from the specified tray, and executes a print process on the paper. Hereinafter, the tray specified in the print information will be referred to as a “specified tray”. When a print process is performed using a plurality of types of paper, an item of a parameter that specifies the range of pages is specified in the setting of the print information, and further a tray is specified for each range, for example.

In step S102, the processor 40A determines whether or not identification information has been received. The identification information is information set on the print information setting screen 600. FIG. 12 illustrates an example in which identification information “XYZ” is set to an item 221 on the print information setting screen 600. When identification information is set in the print information, the processor 40A determines that identification information has been received. The character string for the identification information is determined as appropriate by the user. While identification information is set to the item 221 in the example illustrated in FIG. 12, this is not limiting, and identification information may be set to a different parameter. For example, identification information may be set to a parameter for a job name in an item 200, such as “XXXX print_album@XYZ”. It may be determined in advance the parameter in which item identification information is set to.

When identification information has been set on the print information setting screen 600 (YES in step S102), the processor 40A executes the process in step S104. When identification information has not been set on the print information setting screen 600 (NO in step S102), the processor 40A executes the process in step S106.

In step S104, the processor 40A outputs print data with the identification information to the image forming apparatus 10.

In step S106, the processor 40A outputs print data with no identification information to the image forming apparatus 10.

When the server 40 is not included, the process illustrated in FIG. 11 may be executed by the processor 20A. While a tray is specified in the print information in the above setting of the print information, paper information may be specified rather than a tray.

The identification information etc. set in the print information is registered in the management table 300 in the storage section 10G.

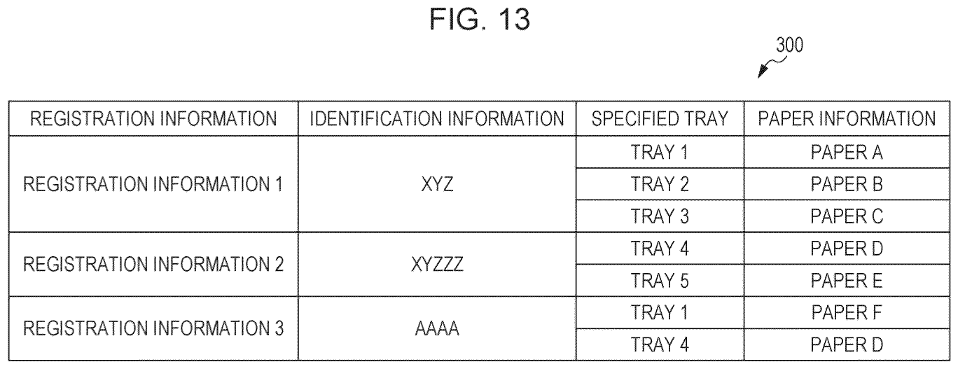

FIG. 13 illustrates an example of the management table 300 stored in the storage section of the image forming apparatus. When the tray 1, the tray 2, and the tray 3 are set as specified trays, for example, and identification information “XYZ” is set in the print information, “XYZ” is registered in an identification information field in the management table 300. In addition, respective pieces of the correlation information about the specified trays are registered on the basis of the correlation information 60 registered in advance in the storage section 10G in a specified tray field and a paper information field. That is, at least one piece of paper information is registered for one piece of identification information in the management table 300 as one piece of registration information. Specifically, information in the correlation information A, the correlation information B, and the correlation information C indicated in FIG. 3, for example, is registered as registration information 1 for print information in which “XYZ” is set as identification information and the tray 1, the tray 2, and the tray 3 are set as specified trays. In the management table 300 in FIG. 13, the name of paper is indicated as the paper information. When paper information is specified in the print information, correlation information based on the specified paper information is registered, for example.

In the manner described above, a set of identification information set to one piece of print information and at least one piece of correlation information is registered in the management table 300 as one piece of registration information.

The registration information may be registered in advance by the user. For example, the user is able to register identification information “XYZZZ”, the correlation information D indicated in FIG. 3, and correlation information about a tray 5 (not illustrated) in the management table 300 as registration information 2 using the user interface 10K. In the manner described above, the user is able to register identification information and at least one piece of correlation information in the management table 300 as one piece of registration information. Consequently, it is possible to execute a print process without the user setting paper information for a specified tray, by setting identification information that has been registered in print information when executing a print process using paper information that has been registered. In addition, it is possible to reuse setting of paper information for a specified tray, by registering correlation between the tray and paper information using identification information.

The management table 300 also includes, as registered therein, information registered by the user in the past and information registered in accordance with print data with identification information received in the past, for example. For example, registration information 3 in FIG. 13 indicates registration information registered when paper F was stored in the tray 1.

Next, a process performed by the image forming apparatus 10 upon receiving print data will be described.

FIG. 14 is a flowchart illustrating operation of the image forming apparatus 10. The process indicated in FIG. 14 is started when the information processing program 100 is started when the image forming apparatus 10 receives print data.

In step S200, the processor 10A receives print data.

In step S202, the processor 10A determines whether or not the received print data are provided with identification information. When print data with identification information have been received (YES in step S202), the processor 10A executes the process in step S204. When print data with no identification information have been received (NO in step S202), the processor 10A executes the process in step S210.

In step S204, the processor 10A determines whether or not identification information for any piece of the registration information registered in the management table 300 matches the identification information provided to the print data. When matching is made (YES in step S204), the processor 10A executes the process in step S208. When no matching is made (NO in step S204), the processor 10A executes the process in step S206.

In step S206, the processor 10A correlates the identification information provided to the print data and the correlation information about the specified tray, and registers the correlated information in the management table 300 as new registration information. When paper information is specified in the print information, new registration information obtained by correlating the identification information provided to the print data with the correlation information about the specified paper information is registered in the management table 300.

In step S208, the processor 10A executes a print process for print data by correlating the specified tray with paper information using the registration information registered in the management table 300. When paper information is specified in the print information, a print process is executed by correlating the specified paper information with a tray on the basis of the registration information, for example.

In step S210, the processor 10A executes a print process for print data by correlating the specified tray with paper information using the correlation information 60 registered in advance. When paper information is specified in the print information, a print process is executed by correlating the specified paper information with a tray on the basis of the correlation information 60.

In steps S208 and S210, a print process for print data is executed on paper transported from the specified tray on the basis of print information for the data.

Through the process described above, it is possible to execute a print process without the need for the user to correlate a specified tray and paper information on the user interface 10K each time a print process is executed, when executing a print process for print data. In addition, it is possible to register new registration information in the management table 300 without the user operating the user interface 10K, by providing print information with identification information that has not been registered.

When the correlation information 60 is updated by replacing paper stored in a tray etc., the image forming apparatus 10 may execute a process illustrated in FIG. 15.

FIG. 15 is a flowchart illustrating another example of operation of the image forming apparatus 10. Processes illustrated in FIG. 15 that are similar to those illustrated in FIG. 14 are denoted by the same reference numerals to omit description thereof.

In step S300, the processor 10A determines whether or not at least one piece of the correlation information 60 has been updated in a certain period from the time when print data are received, for example. The certain period is a duration determined in advance. For example, an affirmative determination is made when at least one piece of the correlation information 60 has been updated, by replacing paper stored in any tray etc., within 15 minutes from the reception of print data.

When the correlation information 60 is updated in the certain period (YES in step S300), the processor 10A executes the process in step S302. When the correlation information 60 is not updated in the certain period (NO in step S300), the processor 10A executes the process in step S202.

In step S302, the processor 10A determines whether or not the received print data are provided with identification information. When print data with identification information have been received (YES in step S302), the processor 10A executes the process in step S304. When print data with no identification information have been received (NO in step S302), the processor 10A executes the process in step S312.

In step S304, the processor 10A determines whether or not identification information for any piece of the registration information registered in the management table 300 matches the identification information provided to the print data. When matching is made (YES in step S304), the processor 10A executes the process in step S306. When no matching is made (NO in step S304), the processor 10A executes the process in step S310.

In step S306, the processor 10A determines whether or not setting about overwriting of registration information is activated in the print information. Whether or not setting about overwriting is activated is determined on the basis of whether or not an item 222 is selected on the print information setting screen 600 illustrated in FIG. 12, for example. When the item 222 is selected, the processor 10A determines that setting about overwriting is activated. When the item 222 is selected (YES in step S306), the processor 10A executes the process in step S308. When the item 222 is not selected (NO in step S306), the processor 10A executes the process in step S314.

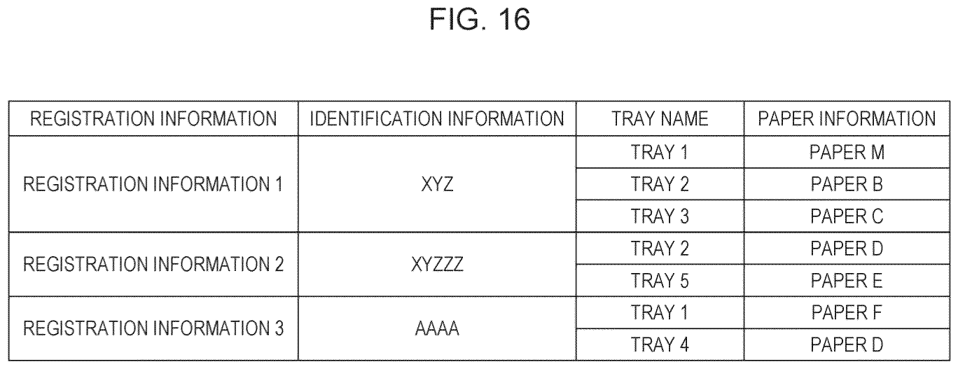

In step S308, the processor 10A updates the correlation information in the registration information with the identification information matching the identification information provided to the print data using the updated correlation information 60 in the management table 300. For example, when the identification information “XYZ” is provided to the print data and the paper information about the tray 1 as the specified tray is updated as in the example in FIG. 8, the registration information 1 in the management table 300 is updated as indicated in FIG. 16. More particularly, the “paper A” in the paper information for the tray 1 in the registration information 1 in FIG. 13 is updated to “paper M” and registered in FIG. 16 as the correlation information 60 is updated to the setting illustrated in FIG. 8.

In step S310, the processor 10A correlates the identification information provided to the print data and the updated correlation information 60, and registers the correlated information in the management table 300 as new registration information.

In step S312, the processor 10A executes a print process using paper information according to the registration information newly registered in accordance with the updated correlation information 60, or the updated registration information in the management table 300. That is, in step S312, a print process is executed by correlating the specified tray with paper information according to the updated correlation information 60. When paper information is specified in the print information, a print process is executed by correlating the specified paper information with a tray on the basis of the registration information, for example.

In step S314, the processor 10A executes a print process using paper information according to the updated correlation information 60. Particularly, a print process is executed by correlating the specified tray with paper information according to the updated correlation information 60 without updating the registration information in the management table 300. When paper information is specified in the print information, a print process is executed by correlating the specified paper information with a tray using the updated correlation information 60.

In the example described above, when print data with identification information are received, it is possible to execute a print process using paper information according to the updated correlation information 60, even if the correlation information 60 is updated immediately before the print data are received. When paper information is specified in the print information, it is possible to execute a print process using a tray in the updated correlation information 60. Through the process described above, it is possible to update the registration information in the management table 300 without the user operating the user interface 10K, even when the correlation information is updated immediately before a print process for print data. In addition, it is possible to execute a print process using the updated correlation information 60 without the user operating the user interface 10K.

When setting print information for print data with identification information, the user is able to make setting so as to further add a specified tray in setting of the print information illustrated in FIG. 12. Particularly, it is assumed that the tray 1, the tray 2, the tray 3, and a tray 8, for example, are set as specified trays and identification information “XYZ” is further set in the print information. When the image forming apparatus 10 receives print data that include such print information, the processor 10A correlates the tray 1, the tray 2, and the tray 3 with paper information using the registration information 1 in the management table 300 indicated in FIG. 13, for example. Since paper information in the registration information 1 may not be used for the tray 8 as a specified tray, the processor 10A uses correlation information about an additional tray, among the correlation information 60 determined in advance, for the tray 8.

As in the above process, when identification information is specified in setting print information, a tray not registered in the registration information with identification information matching the specified identification information in the management table 300 may be set as a specified tray for the print information. A specified tray that is not registered in the registration information including identification information matching identification information in the management table 300 as described above and that has been newly added is referred to as an “additional tray”.

When identification information for any piece of the registration information registered in the management table 300 and the identification information provided to the print information match each other, and an additional tray is set in the print information, the processor 10A is able to update the registration information so as to add correlation information about the additional tray to the registration information with the matching identification information. This process may be performed to update the registration information when an affirmative determination is made in the process in step S306, for example. Through the process described above, it is possible to update the registration information in the management table 300 without the user operating the user interface 10K, when an additional tray is specified. In addition, it is possible to execute a print process using the additional tray without the user operating the user interface 10K.

While an exemplary embodiment has been described above, the technical scope of the present disclosure is not limited to the above exemplary embodiment. The above exemplary embodiment may be modified or improved in various ways without departing from the spirit and scope of the present disclosure, and such modified or improved forms are also included in the technical scope of the present disclosure.

The above exemplary embodiment does not limit the disclosure according to the claims, and all combinations of the features described in relation to the exemplary embodiment are not always necessary to the solution according to the disclosure. A variety of disclosures is included in the exemplary embodiment discussed earlier, and the variety of disclosures is extracted in accordance with combinations of a plurality of constituent elements disclosed. Even if some constituent elements are removed from all the constituent elements described in relation to the exemplary embodiment, components left after removing such constituent elements may be extracted as a disclosure as long as an effect may obtained.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

While the information processing program is installed in the storage section 10G in the present exemplary embodiment, this is not limiting. While the print setting program is installed in the storage section 40D in the present exemplary embodiment, this is not limiting. The information processing program 100 and the print setting program according to the present exemplary embodiment may be provided in the form of being stored in a computer-readable storage medium. For example, the application programs according to the present exemplary embodiment may be provided in the form of being stored in an optical disc such as a Compact Disc (CD)-ROM and a Digital Versatile Disc (DVD)-ROM, or in the form of being stored in a semiconductor memory such as a Universal Serial Bus (USB) memory and a memory card. Alternatively, the information processing program 100 and the print setting program according to the present exemplary embodiment may be acquired from an external device via the communication section 10J, 20E, or 40E.

While the processes performed by the image forming apparatus 10 and the server 40 are implemented by software components using a computer by executing a program in the above exemplary embodiment, the present disclosure is not limited thereto. For example, information processing may be implemented by hardware components or a combination of hardware components and software components.

Besides, the components of the image forming apparatus 10, the PC 20, and the server 40 described in relation to the above exemplary embodiment are exemplary, and it should be understood that unnecessary portions may be removed and new portions may be added without departing from the spirit and scope of the present disclosure.

The process flows (see FIGS. 11, 14, and 15) of the information processing program 100 and the print setting program described in relation to the above exemplary embodiment are also exemplary, and it should be noted that unnecessary steps may be removed, new steps may be added, and the order of the processes may be changed without departing from the spirit and scope of the present disclosure.

The display screens (see FIGS. 4 to 8) described in relation to the above exemplary embodiment are also exemplary, and it should be noted that unnecessary elements may be removed, new elements may be added, and design changes such as changing the arrangement of elements in an image and increasing and reducing the size of elements may be made without departing from the spirit and scope of the present disclosure.

### APPENDIX

(((1)))

An information processing system comprising:
a processor configured to:
   register a plurality of pieces of correlation information indicating correlation between a tray and paper information about paper and registration information in which at least one of the plurality of pieces of correlation information and identification information are correlated with each other; and
   execute a print process when identification information included in received print data matches identification information in the registration information, the print process being executed using the paper information based on the registration information with the matching identification information.
      (((2)))

The information processing system according to (((1))),
wherein the processor is configured to correlate the identification information included in the print data and the correlation information about a tray to be used in the print process and register the correlated information as new registration information when the identification information included in the print data does not match the identification information in the registration information.
   (((3)))

The information processing system according to (((1))) or (((2))),
wherein the processor is configured to execute the print process when identification information included in print data received in a predetermined period after at least one of the plurality of pieces of correlation information is updated matches the identification information in the registration information, the print process being executed using the paper information based on the updated correlation information.
   (((4)))

The information processing system according to (((3))),
wherein the processor is configured to overwrite the correlation information in the registration information with the matching identification information with the updated correlation information when setting about overwriting is activated.
   (((5)))

The information processing system according to any one of (((1))) to (((4))),
wherein the processor is configured to execute the print process when the identification information included in the print data matches the identification information in the registration information and a tray to be used in the print process includes an additional tray, the print process being executed using the paper information based on the registration information with the matching identification information for a tray other than the additional tray, and using the paper information based on the correlation information about the additional tray for the additional tray.
   (((6)))

The information processing system according to (((5))),
wherein the processor is configured to update the correlation information so as to add the correlation information about the additional tray to the registration information with the matching identification information.
   (((7)))

The information processing system according to any one of (((1))) to (((6))),
wherein the identification information included in the print data is added to a name of the print data or a parameter of the print data.
   (((8)))

A non-transitory computer readable medium storing a program causing a computer to execute a process comprising:
registering a plurality of pieces of correlation information indicating correlation between a tray and paper information about paper and registration information in which at least one of the plurality of pieces of correlation information and identification information are correlated with each other; and
executing a print process when identification information included in received print data matches identification information in the registration information, the print process being executed using the paper information based on the registration information with the matching identification information.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a processor configured to:
register a plurality of pieces of correlation information indicating correlation between a tray and paper information about paper and registration information in which at least one of the plurality of pieces of correlation information and identification information are correlated with each other; and
execute a print process when identification information included in received print data matches identification information in the registration information, the print process being executed using the paper information based on the registration information with the matching identification information.

2. The information processing system according to claim 1,
wherein the processor is configured to correlate the identification information included in the print data and the correlation information about a tray to be used in the print process and register the correlated information as new registration information when the identification information included in the print data does not match the identification information in the registration information.

3. The information processing system according to claim 1,
wherein the processor is configured to execute the print process when identification information included in print data received in a predetermined period after at least one of the plurality of pieces of correlation information is updated matches the identification information in the registration information, the print process being executed using the paper information based on the updated correlation information.

4. The information processing system according to claim 3,
wherein the processor is configured to overwrite the correlation information in the registration information with the matching identification information with the updated correlation information when setting about overwriting is activated.

5. The information processing system according to claim 1,
wherein the processor is configured to execute the print process when the identification information included in the print data matches the identification information in the registration information and a tray to be used in the print process includes an additional tray, the print process being executed using the paper information based on the registration information with the matching identification information for a tray other than the additional tray, and using the paper information based on the correlation information about the additional tray for the additional tray.

6. The information processing system according to claim 5,
wherein the processor is configured to update the correlation information so as to add the correlation information about the additional tray to the registration information with the matching identification information.

7. The information processing system according to claim 1,
wherein the identification information included in the print data is added to a name of the print data or a parameter of the print data.

8. The information processing system according to claim 2,
wherein the identification information included in the print data is added to a name of the print data or a parameter of the print data.

9. The information processing system according to claim 3,
wherein the identification information included in the print data is added to a name of the print data or a parameter of the print data.

10. The information processing system according to claim 4,
wherein the identification information included in the print data is added to a name of the print data or a parameter of the print data.

11. The information processing system according to claim 5,
wherein the identification information included in the print data is added to a name of the print data or a parameter of the print data.

12. The information processing system according to claim 6,
wherein the identification information included in the print data is added to a name of the print data or a parameter of the print data.

13. A method comprising:
registering a plurality of pieces of correlation information indicating correlation between a tray and paper information about paper and registration information in which at least one of the plurality of pieces of correlation information and identification information are correlated with each other; and
executing a print process when identification information included in received print data matches identification information in the registration information, the print process being executed using the paper information based on the registration information with the matching identification information.

14. A non-transitory computer readable medium storing a program causing a computer to execute a process comprising:
registering a plurality of pieces of correlation information indicating correlation between a tray and paper information about paper and registration information in which at least one of the plurality of pieces of correlation information and identification information are correlated with each other; and
executing a print process when identification information included in received print data matches identification information in the registration information, the print process being executed using the paper information based on the registration information with the matching identification information.
